(19) United States
(12) Patent Application Publication
(10) Pub. No.: US 2011/0236194 A1
(43) Pub. Date: Sep. 29, 2011

(54) FAN APPARATUS WITH AIR DUCT

(75) Inventors: TING GE, Shenzhen City (CN); YA-JUN PAN, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/788,308

(22) Filed: May 27, 2010

(30) Foreign Application Priority Data
Mar. 25, 2010 (CN) 201010132370.2

(51) Int. Cl. F04D 19/00; F16L 9/14

(52) U.S. Cl. 415/182.1; 138/140

(57) ABSTRACT

An air duct includes a cover and two adjusting pieces. The cover includes a top board and two end boards extending downwards from two opposite ends of the top board. The cover defines an air outlet in a front of the cover and an air intake in a rear of the cover. Two adjusting pieces are slantingly extended from rear ends of the two side boards toward the air outlet.

### BACKGROUND

1. Technical Field

The present disclosure relates to a fan apparatus with an air duct.

2. Description of Related Art

Referring to FIG. 1, a conventional server usually uses many fans 2 arranged at a rear of a motherboard 1 of the server in parallel to form a fan module in a server case 90 (see FIG. 2A), to dissipate heat for some heating elements of the server. For example, these heating elements may include memory chips 3, a central processing unit (CPU) covered by a first heat sink 4, and a north bridge chip covered by a second heat sink 5.

The fan module has been built in redundancy with the inclusion of many fans, and if one of the fans 2 is disabled, the other fans 2 can still work normally. However, when one of the fans 2 is disabled, the airflow flowing through the disabled fan 2 is greatly reduced, which may influence heat dissipating effect of the server. Three paragraphs in FIGS. 2A-2C show three simulated flow fields of a conventional fan module in three states, to explain why the heat dissipating effect of the conventional redundancy fan module is not effective in case one of the fans of the fan module is malfunctioning.

FIG. 2A shows a flow field of the motherboard 1 when the fans 2 all work. The airflow generated by the two side fans 2 produces backflow, which can influence heat dissipating effect.

FIG. 2B shows a flow field of the motherboard 1 when one side fan 2 of the fans 2 adjacent to the memory chips 3 is disabled. Because one side fan 2 of the fans 2 is disabled, the memory chips 3 cannot be cooled effectively.

FIG. 2C shows a flow field of the motherboard 1 when the middle fan 2 adjacent to the first heat sink 4 is disabled. Because the middle fan 2 is disabled, the CPU covered by the first heat sink 4 cannot be cooled effectively.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an isometric, schematic view of a conventional fan module, together with a motherboard.

FIGS. 2A, 2B, and 2C are simulated flow field views of the motherboard using the fan module of FIG. 1, in three different states.

FIG. 3 is an isometric, schematic view of an embodiment of an air duct.

FIG. 4 is an isometric, schematic view of an embodiment of a fan apparatus with the air duct of FIG. 3, together with a motherboard.

FIGS. 5A, 5B, and 5C are flow field views of the motherboard using the fan apparatus of FIG. 4, in three different states.

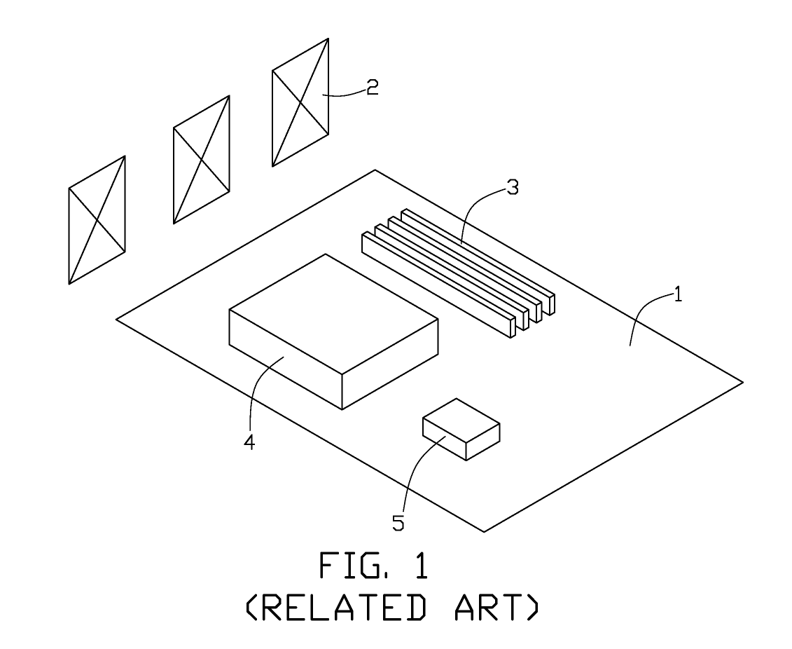

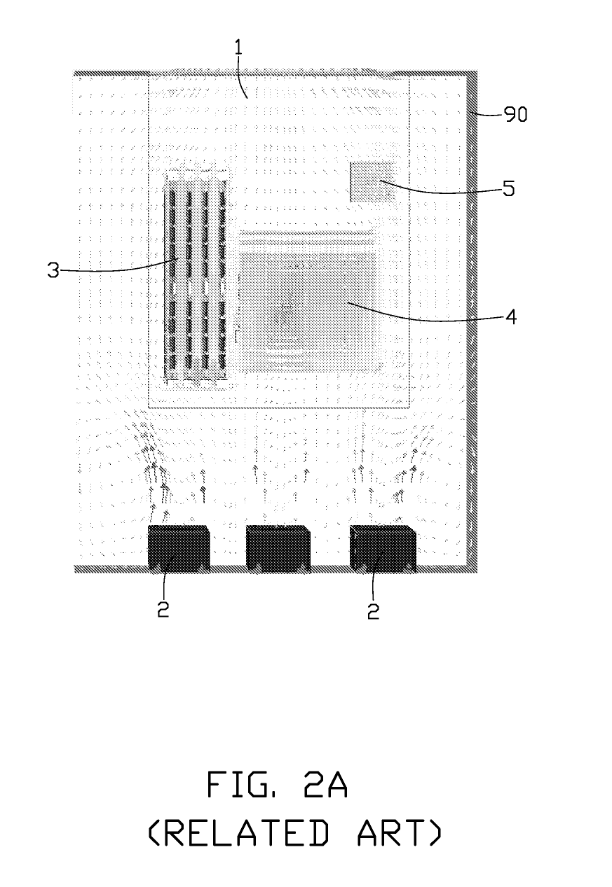

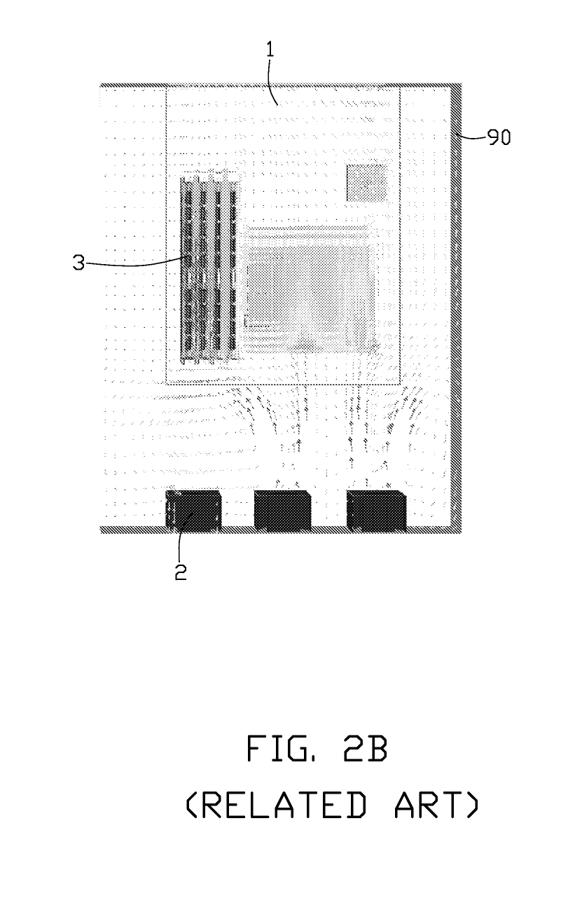

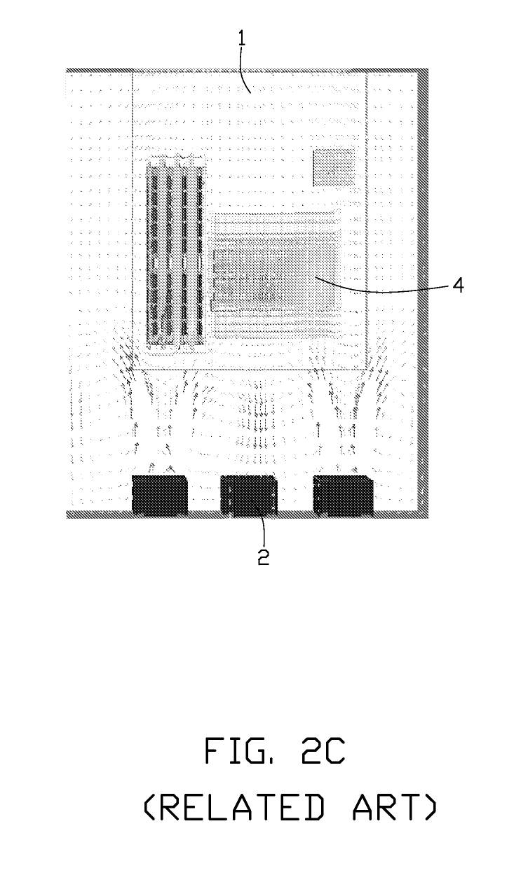

### DETAILED DESCRIPTION

The disclosure, including the accompanying drawing, is illustrated by way of example and not by way of limitation. It should be noted that references to “an” or “one” embodiment in this disclosure are not necessarily to the same embodiment, and such references mean at least one.

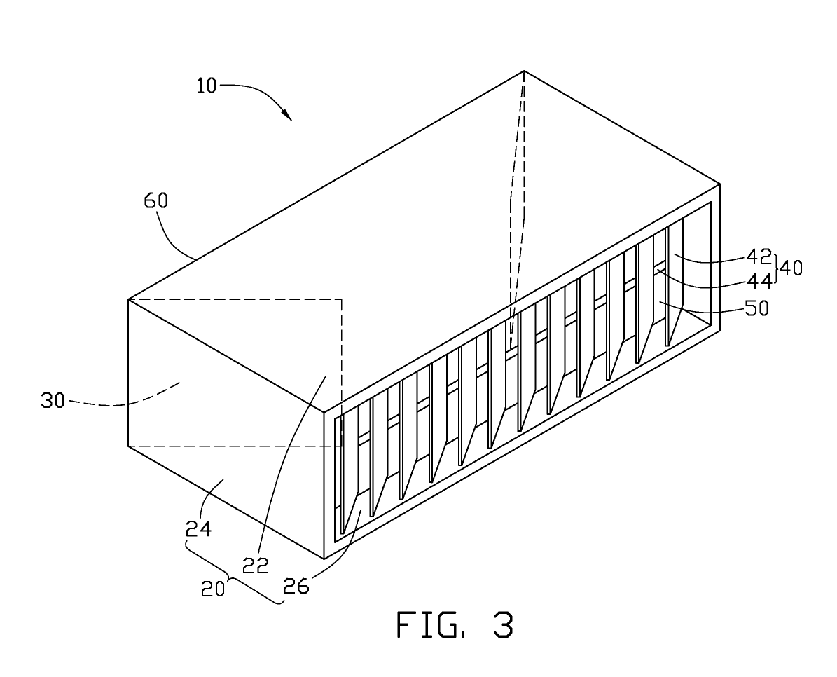

Referring to FIG. 3, an embodiment of an air duct 10 includes a cover 20, two rectangular adjusting pieces 30, and an airflow guide 40.

The cover 20 includes a rectangular top board 22, and two rectangular end boards 24 perpendicularly extending downwards from two opposite ends of the top board 22. The cover 20 defines an air outlet 50 in a front of the cover 20 and an air intake 60 in a rear of the cover 20. The cover 20 further includes a narrow base board 26 connected between front ends of bottoms of the side boards 24, to bound the air outlet 50 together with the top board 22 and the end boards 24.

The two adjusting pieces 30 are arranged at the air intake 60 of the cover 20 and vertical to the top board 22. The two adjusting pieces 30 are respectively slantingly extended from rear ends of the two side boards 24 toward the air outlet 50, and each adjusting piece 30 has a same height as the two side boards 24. In one embodiment, an angle between each adjusting piece 30 and the corresponding side board 24 is about thirty degrees.

The airflow guide 40 is mounted at the air outlet 50 between the top board 22 and the base board 26, for adjust airflow direction. The airflow guide 40 includes a plurality of parallel guide boards 42 and a connection pole 44. Each guide board 42 is rotatablly mounted between the top board 22 and the base board 26, a rotation shaft of each guide board 40 is perpendicular to the top board 22 and the base board 26. The connection pole 44 is fixed to rear sides of the guide boards 42 to make the guide boards 42 rotate synchronously.

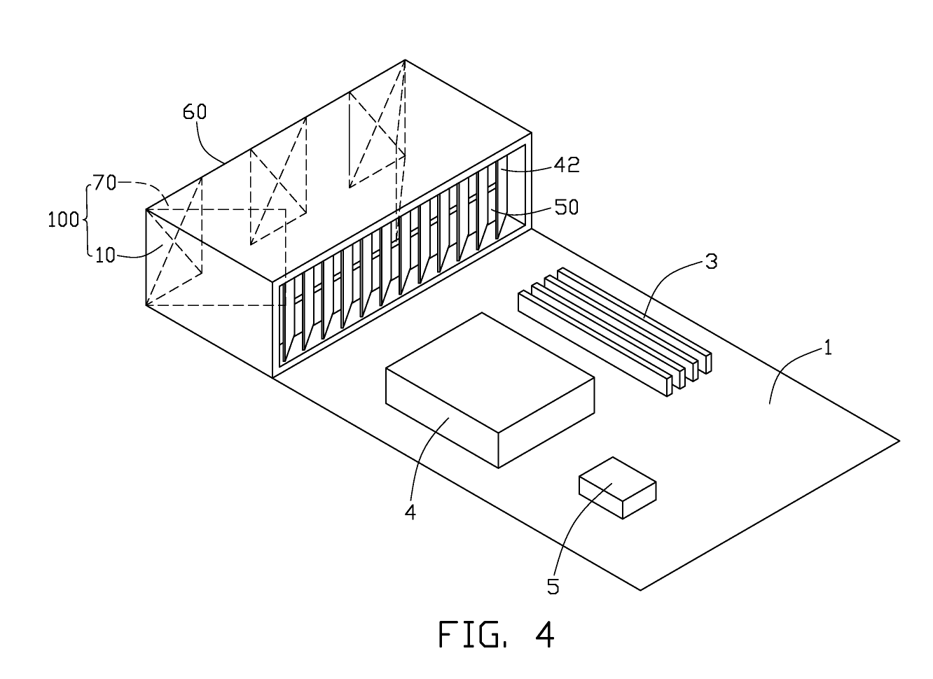

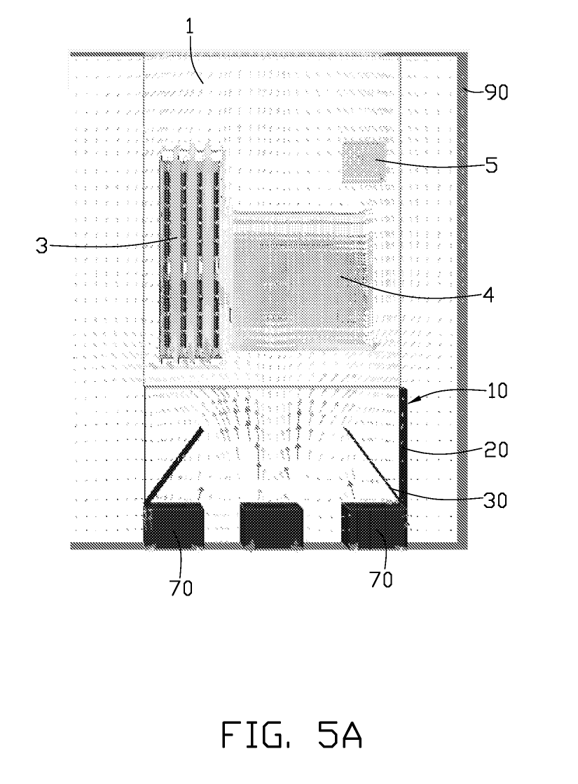

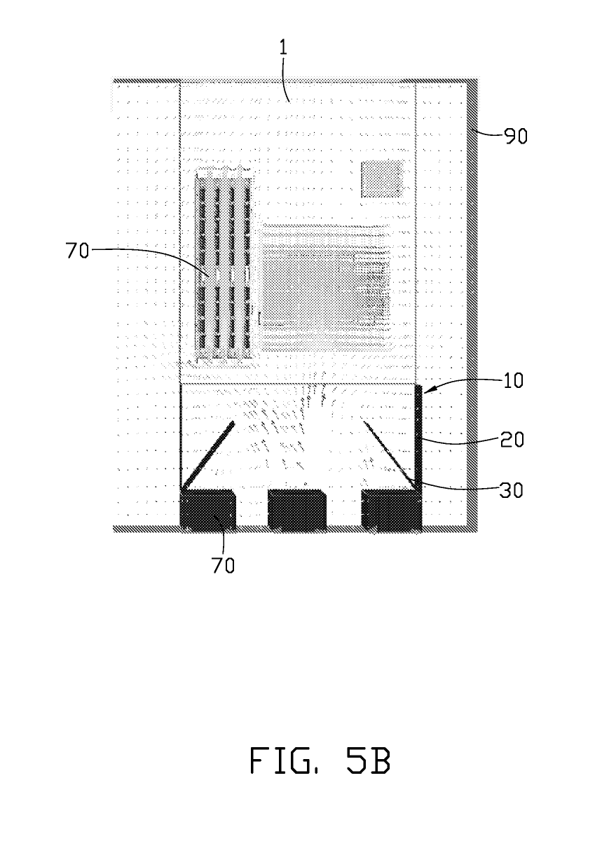

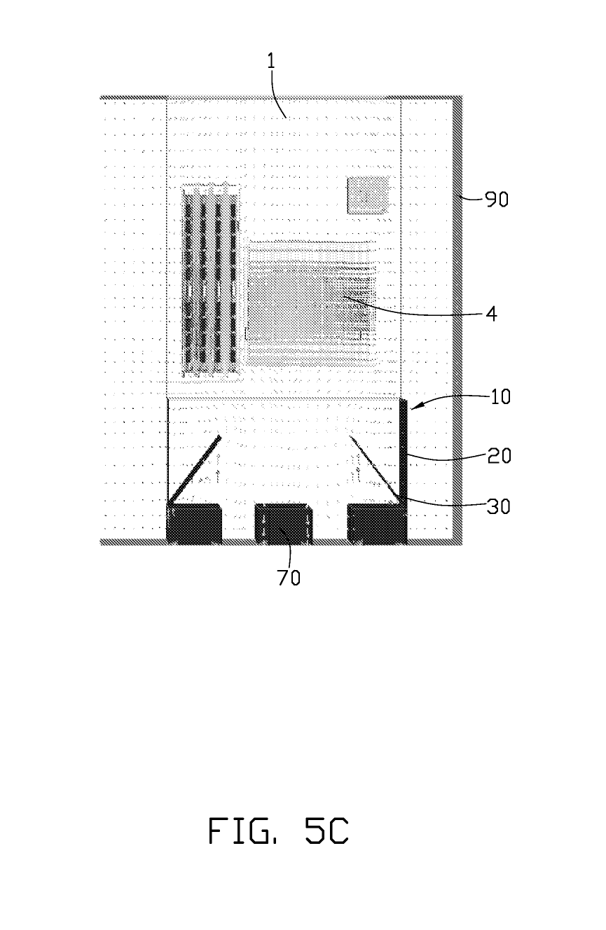

Referring to FIG. 4, in use, the air duct 10 is arranged in a server case 90 (see FIGS. 5A, 5B, 5C). The air intake 60 faces three fans 70, and the air outlet 50 faces some heat generating elements, such as memory chips 3, a central processing unit (CPU) covered by a first heat sink 4, and a north bridge chip covered by a second hear sink 5. The fans 70 together with the air duct 10 form a fan apparatus 100 for cooling these heat generating elements in the server case 90. The following three paragraphs explain three simulating flow fields of the fan apparatus.

FIG. 5A shows a flow field of the motherboard 1 using the fan apparatus 100 when the fans 70 all work. The airflow generated by the three fans 70 is concentrated at the motherboard 1 guided by the air duct 10, which can increase heat dissipating effect.

FIG. 5B shows a flow field of the motherboard 1 using the fan apparatus 100 when one side fan 70 of the fans 70 is disabled. Because the adjusting pieces 30 can concentrate the airflow generated by the other fans 70, the concentrated airflow from the air duct 10 can equably dissipate all of the heating elements. Furthermore, the airflow guide 40 can be adjusted according to arrangement of the heating elements.

FIG. 5C shows a flow field of the motherboard 1 using the fan apparatus 100 when the middle one of the fans 70 is disabled. Because the adjusting pieces 30 can concentrate the airflow generated by the other fans 70, the concentrated airflow from the air duct 10 can equably dissipate all heating elements.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. An air duct comprising:
a cover comprising a top board and two end boards extending downwards from two opposite ends of the top board; wherein the cover defines an air outlet in a front of the cover and an air intake in a rear of the cover; and
two adjusting pieces slantingly extending from rear ends of the two side boards toward the air outlet.

2. The air duct of claim 1, wherein an angle between each adjusting piece and the corresponding end board is about thirty degrees.

3. The air duct of claim 2, wherein the adjusting pieces have a same height as the two end boards.

4. The air duct of claim 1, further comprising an airflow guide, wherein the cover further comprises a base board connected between front ends of bottoms of the end boards, to bound the air outlet together with the top board and the end boards, wherein the airflow guide is mounted at the air outlet and between the top board and the base board, to adjust airflow direction.

5. The air duct of claim 4, wherein the airflow guide comprises a plurality of parallel guide boards and a connection pole, each of the guide boards is rotatably mounted between the top board and the base board, the connection pole is fixed to rear sides of the guide boards to make the guide boards rotate synchronously.

6. The air duct of claim 5, wherein a rotation shaft of each guide board is perpendicular to the top board and the base board.

7. A fan apparatus comprising:
a cover comprising a top board and two end boards extending downwards from two opposite ends of the top board; wherein the cover defines an air outlet in a front of the cover and an air intake in a rear of the cover;
two adjusting pieces slantingly extending from rear ends of the two side boards toward the air outlet; and
a plurality of fans arranged at the air intake.

8. The fan apparatus of claim 7, wherein an angle between each adjusting piece and the corresponding end board is about thirty degrees.

9. The fan apparatus of claim 8, wherein the adjusting pieces have a same height as the two end boards.

10. The fan apparatus of claim 7, further comprising an airflow guide, wherein the cover further comprises a base board connected between front ends of bottoms of the end boards, to bound the air outlet together with the top board and the end boards, the airflow guide is mounted at the air outlet and between the top board and the base board, to adjust airflow direction.

11. The fan apparatus of claim 10, wherein the airflow guide comprises a plurality of parallel guide boards and a connection pole, each of the guide boards is rotatably mounted between the top board and the base board, the connection pole is fixed to rear sides of the guide boards to make the guide boards rotate synchronously.

12. The fan apparatus of claim 11, wherein a rotation shaft of each guide board is perpendicular to the top board and the base board.

13. The fan apparatus of claim 7, wherein the number of the plurality of fans is three.
